(19) United States
(12) Patent Application Publication
(10) Pub. No.: US 2009/0280453 A1
(43) Pub. Date: Nov. 12, 2009

(54) Device for a dental treatment

(76) Inventor: Bernd Detje, Hamburg (DE)

Correspondence Address: ALIX YALE & RISTAS LLP, 750 MAIN STREET, SUITE 1400, HARTFORD, CT, 06103, US

(21) Appl. No.: 12/311,003

(22) PCT Filed: Sep. 14, 2007
(86) PCT No.: PCT/EP2007/008032

§ 371 Date: Mar. 16, 2009

(30) Foreign Application Priority Data
Sep. 14, 2006 (DE) 10 2006 043 131.6

(51) Int. Cl. A61C 13/225

(52) U.S. Cl. 433/172

(57) ABSTRACT

The device for a dental treatment using at least one retention pin to be inserted into the root canal of teeth, and a container, having at least one sac bore for receiving the retention pin is characterized in that the retention pin is equipped with a coating, and is connected to a retainer at its one end in a releasable manner, which is removably placed into the sac bore, or inserted into the same such that the retention pin is retained centered at a distance of the walls of the sac bore, and in that the sac bore is sterilized with the retention pin and hermetically sealed.

### BACKGROUND

The invention relates to a device for a dental treatment, with at least one retention pin to be inserted into the root canal of teeth, and with a container having at least one blind bore for receiving the retention pin/retention pins.

Retention pins are used in dentistry to securely hold crowns, bridges or direct restorations (fillings) if there is no longer enough tooth substance to do this. They are secured mainly by what is called the adhesive technique, which is known to a person skilled in the art. Part of the retention pin is bonded with a dental securing cement into the prepared root canal. The remaining part protrudes from the root canal. The direct restoration is shaped on this remaining part, or a tooth stump is built up onto which the crown or bridge is in turn cemented. Modern dental cements and direct restoration materials or stump support materials are based on more or less highly filled (meth)acrylic resin composites or compomers.

In pin supports of this kind, it is important that the cement adheres well to the wall of the root canal and that the retention pin adheres securely to the cement. For this purpose, it is necessary to provide the retention pin with a coating before inserting it into the root canal. Of course, the pin also has to be sterilized before being inserted into the root canal. A customary coating is, for example, a silane, e.g. 3-methacryloxypropyltrimethoxysilane, which improves the bond between the retention pin and the cement and by means of which the pin is secured in the root canal.

The silane must hydrolyze here, and the resulting hydroxyl groups can react with the surface of the retention pin. The silane also contains a polymerizable group, for example methacrylate. First, the surface of the retention pin is made hydrophobic by the methacryl group. This is advantageous if the binder/cement and/or tooth replacement material is hydrophobic. Second, the methacryl group of the silane can be crosslinked with the binder/cement and/or tooth replacement material. The binder preferably also contains polymerizable (meth)acrylates, preferably dimethacrylates or higher-functionality methacrylates. The binder can also be cured or partially cured. However, it is also possible to apply an adhesion promoter layer without silane. This can contain other adhesion groups, for example acid groups, e.g. a phosphonic acid group, which can react with the inorganic constituents of the pin. It is also possible to apply an adhesion promoter layer which is bound to the pin via the organic constituents of a composite pin. The adhesion promoter layer can also adhere simply by means of the monomer of an adhesion promoter solution penetrating into microretentions, which are present or artificially created on the pin, being polymerized there and thus generating a firm mechanical hold.

The coating with silane or with another of the aforementioned materials is usually done by the dentist, who also first has to sterilize the retention pin. The retention pin must also be touched as little as possible throughout the procedure, in order not to contaminate it again.

The preliminary treatment by the dentist involved applying the necessary liquids by means of a brush or the like and, if appropriate, then allowing them to set. The disadvantage of this is that the dentist has to keep a supply of the liquids, these have to be in an optimal condition, the application procedure is awkward and time-consuming, the surface coating is not always optimal, and unfavorable material combinations between cement, adhesive, silane and pin may arise if products from different suppliers or of different ages are used or if ineffective adhesive systems are employed. Finally, it is unfavorable, as regards the treatment, that the pretreated pin has to be securely held by forceps or the like throughout the coating procedure.

In a proposed device of the type mentioned at the outset, the retention pins are held in a container in blind bores, which are closed and from which the dentist can remove the retention pins. Although this makes storage and selection of the retention pins easier for the dentist, the abovementioned problems of sterilization and coating still exist.

### SUMMARY

A device is created of the type mentioned at the outset, which permits optimal coating, safe storage, such that no contamination or damage occurs, and easier handling by the dentist.

The retention pin is provided with the coating and, at one end, is connected releasably to a holder, which is releasably placed onto the blind bore or inserted into the same such that the retention pin is held centered at a distance from the wall of the blind bore, and such that the blind bore with the retention pin is closed in an airtight manner.

The retention pin is therefore supplied to the dentist already with the correct coating and in a sterile state. The retention pin is held in the blind bore in such a way that it does not touch the wall. The blind bore, with the retention pin enclosed therein, is closed in an airtight manner, such that the retention pin, which has been sterilized, is kept sterile. When the dentist wishes to implant the retention pin, he grips the holder and can insert the retention pin into the root canal without touching the retention pin. When the retention pin has been adequately fixed by the hardening cement, the holder, releasably secured on the retention pin, can be removed and the dental treatment completed.

Therefore, retention pins are made available which are optimally pretreated at the manufacturing sites and are sterilized. The best acting silanes/adhesives or other coatings can be selected by the manufacturer. The coating method can be optimally adapted to the surfacing process. The required reaction times or hardening times can be perfectly controlled, such that excellent quality is assured and, as a result, the enhanced reliability leads to the best possible end results.

The holder can be enclosed in an airtight manner by a film that is sealed/welded onto the container. This film is then removed when the retention pin is to be used. The holder then lies exposed and can be gripped. The holder can also be gripped along with the film.

In another advantageous embodiment, the holder is sealed/welded onto the container in an airtight manner. In this case, the holder is likewise gripped in order to release it from the container and remove it with the retention pin.

The retention pin can be held by frictional engagement in a bore of the holder. It is thus held safely at a distance from the wall of the container during transport to the dentist and prior to use. Once the retention pin has been cemented into place, the holder can be pulled off.

In another advantageous embodiment, the retention pin is held in a bore of the holder with the aid of a rubber-like compound. A permanently flexible, slightly rubber-like, slightly tacky and non-hardening compound of this kind is introduced into the holder to about ⅔ of the length of the bore. Suitable materials are known and can be processed like a hot-melt adhesive. The upper end of the pin is pressed gently into the deformable, slightly adhesive compound. Because of the low weight of such pins, the slightly adhesive character of the fixing compound and the supporting properties of the bore, the pin is held securely in position during storage in the container and during transfer into the root canal. By gently pulling on the holder when the retention pin has been cemented into place, the connection to the slightly adhesive compound is undone and the pin is freed. Later, when the length of the polymerized-in pin is shortened, the contact site to the fixing compound is removed. Suitable rubber-like compounds for this purpose are hot-melt adhesives (PSA, PSA hotmelts) with a permanently tacky surface and a certain elasticity. An example that may be mentioned here is the product called SikaMelt from Sika AG.

In another embodiment, the retention pin is held in a clamping means releasable by pressure on the holder.

As has already been mentioned, the retention pin is preferably pretreated with silane. Other preferred coating media are light-curing, dual-curing and self-curing dental adhesives, special adhesion promoters (Ecusit Composite Repair), adhesion promoters that improve surface activities, and primers having reactive constituents (e.g. peroxides, salts, metal oxides, etc.).

The device is suitable for all pin materials (e.g. metal). However, the retention pin is preferably a fiber-reinforced composite pin. Composite pins reinforced with glass fiber, composite pins reinforced with quartz fiber, and composite pins reinforced with carbon fiber, have proven particularly suitable.

The container preferably has a plurality of blind bores, which have a corresponding number of retention pins. When a retention pin is removed from the container, the other blind bores remain closed and sterile.

### BRIEF DESCRIPTION OF THE DRAWINGS

The invention is described below on the basis of advantageous illustrative embodiments and by reference to the attached drawings, in which:

FIG. 1 shows a partial view, in cross section, of a first embodiment of a device; and

FIG. 2 shows, in a similar view to that in FIG. 1, a second embodiment of a device.

### DETAILED DESCRIPTION

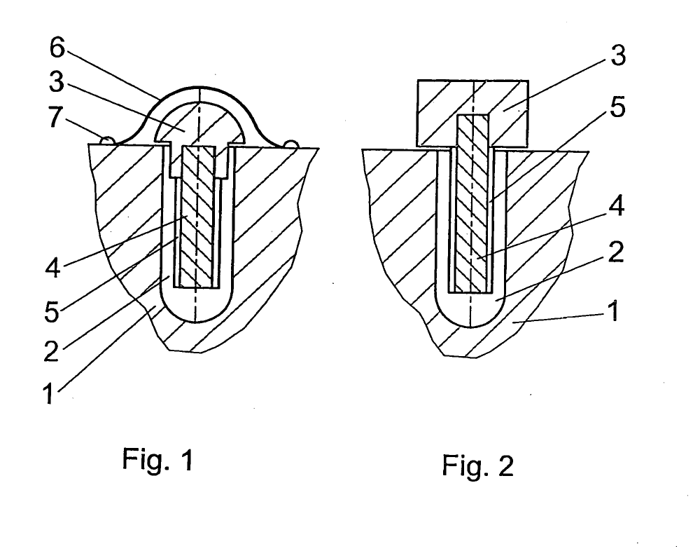

FIG. 1 shows a piece of the container 1 with a blind bore 2. A holder 3, inserted into this blind bore, carries a retention pin 4 in a central bore, which retention pin 4 is provided with a coating on its surface at 5. The holder 3 is enclosed by a film 6 which is welded or sealed onto the container 1 at the edge at 7. The blind bore 2 of the container, with the retention pin 4 contained therein, and the holder 3 are in this case. By means of the airtight closure by the film 6 at 7 of the blind bore 2 of the container, with the retention pin 4 contain therein, and the holder 3, the retention pin is delivered in a sterilized state to the dentist.

In the embodiment in FIG. 2, a film 6 is omitted. Instead, the holder 3 is in this case mounted on the container 1.

1. A device for a dental treatment, with at least one retention pin to be inserted into the root canal of teeth, and with a container having at least one blind bore for receiving the retention pin or retention pins, characterized in that the retention pin is provided with a coating and, at one end, is connected releasably to a holder by being held in a bore of the holder with the aid of a rubber-like compound, and the holder is releasably placed onto the blind bore or inserted into the same such that the retention pin is held centered at a distance from the wall of the blind bore, and such that the blind bore with the retention pin is closed in an airtight manner.

2. The device as claimed in claim 1, characterized in that the holder is enclosed in an airtight manner by a film that is sealed or welded onto the container.

3. The device as claimed in claim 1, characterized in that the holder is sealed or welded onto the container in an airtight manner.

4. The device as claimed in claim 1, characterized in that the retention pin is held by frictional engagement in a bore of the holder.

5. The device as claimed in claim 1, characterized in that the retention pin is held in a clamping means releasable by pressure on the holder.

6. The device as claimed in claim 1, characterized in that the retention pin is pretreated with silane.

7. The device as claimed in claim 1, characterized in that the retention pin is treated with an adhesive.

8. The device as claimed in claim 1, characterized in that the retention pin is a fiber-reinforced composite pin.

9. The device as claimed in claim 1, characterized in that the container has a plurality of blind bores, which have a corresponding number of retention pins.

10. The device as claimed in claim 2, characterized in that the retention pin is held by frictional engagement in a bore of the holder.

11. The device as claimed in claim 3, characterized in that the retention pin is held by frictional engagement in a bore of the holder.

12. The device as claimed in claim 2, characterized in that the retention pin is held in a clamping means releasable by pressure on the holder.

13. The device as claimed in claim 3, characterized in that the retention pin is held in a clamping means releasable by pressure on the holder.

14. The device as claimed in claim 2, characterized in that the retention pin is pretreated with silane.

15. The device as claimed in claim 3, characterized in that the retention pin is pretreated with silane.

16. The device as claimed in claim 2, characterized in that the retention pin is treated with an adhesive.

17. The device as claimed in claim 3, characterized in that the retention pin is treated with an adhesive.

18. The device as claimed in claim 2 characterized in that the retention pin is a fiber-reinforced composite pin.

19. The device as claimed in claim 3 characterized in that the retention pin is a fiber-reinforced composite pin.

20. The device as claimed in claim 9 characterized in that the container has a plurality of blind bores, which have a corresponding number of retention pins.
